(19) United States
(12) Patent Application Publication
(10) Pub. No.: US 2006/0271850 A1
(43) Pub. Date: Nov. 30, 2006

(54) Method and apparatus for transforming a printer into an XML printer

(76) Inventors: Didier Gombert, Laval (CA); Paul Jones, Nijmegen (NL)

Correspondence Address: MCDERMOTT WILL & EMERY LLP, 600 13TH STREET, N.W., WASHINGTON, DC, 20005-3096, US

(21) Appl. No.: 11/418,470

(22) Filed: May 5, 2006

Related U.S. Application Data
(60) Provisional application No. 60/678,197, filed on May 6, 2005.

(51) Int. Cl. G06F 17/00; G06F 9/45

(52) U.S. Cl. 715/523; 715/513; 717/143

(57) ABSTRACT

An XML interpreter adapted to be loaded into a printer and executed by the printer. The XML interpreter receives, stores, navigates through and retrieves XML elements from an incoming data stream and calls a formatting program inside the printer and to allow the formatting program to perform rule-based formatting of the information carried by the XML structure. The XML interpreter has an XML parser for building a DOM tree; and an XPath processor comprising an XPath parser for parsing an XPath string into a data structure and an XPath interpreter which receives the data structure from the XPath parser and retrieves the data from the DOM tree.

### FIELD OF THE INVENTION

The present invention relates to a method and apparatus for transforming a printer, and more particularly, a PostScript printer into an XML printer.

### BACKGROUND OF THE INVENTION

Postscript formatting programs usually receive data as a sequential string of characters that is stored into a buffer. Once the buffer is filled, PostScript commands are used to retrieve data from specific locations in the buffer and incorporate it into the document being built. The buffer is then flushed and a new one is received to start again.

While this method is efficient for unstructured data like the one produced by many printing applications, it cannot be used for data stored in a logical and hierarchical structure like XML, because each XML element may contain a variable number of sub-elements. Therefore, fixed-length buffers to store incoming data streams cannot be used since they might be overrun by the variable length of incoming data. Moreover, because XML is a token-based syntax for organizing data, PostScript programs cannot look at specific physical locations in the data buffer to find specific data elements, again because of the variable nature of the XML structure.

The traditional approach to print an XML structure is to process it at the host computer level with software like variable data printing software, XSL OF, etc. that convert the XML stream to print data, which is in turn processed by the printer using an emulation mode like PCL, PostScript, AFP, IPDS, etc.

The process can be schematized as follows, referring now to FIG. 1 (Prior Art):
1) The host computer processes an XML structure that is either generated or stored.
2) The XML is converted to a human readable presentation by translating it to a Page Description Language (PDL) like PostScript, PCL, IPDS, etc.
3) This PDL is sent to a printer.
4) Finally, the PDL is interpreted by the associated emulation inside the printer to produce the printed document.

One of the issues with the prior art process is that of bandwidth. Indeed, files that are sent to printers are becoming larger and larger, given the capacity of printers to print in colour, and due to the increased resolution of printers. Although this is a minor issue for a home, or small office, based operation, network managers are quickly becoming limited in network resources in larger organizations. This is particularly true for those who print large amounts of forms, where only the data changes, but the whole layout does not, such as invoices. In fact, more and more users are relying on colour printers and plain white paper to print these types of documents, since white paper is much cheaper than pre-printed paper.

### SUMMARY OF THE INVENTION

It is an object of the present invention to provide a method and apparatus for transforming a printer into an XML printer.

In accordance with one aspect of the present invention, there is provided an XML interpreter, said XML interpreter being adapted to be loaded into a printer and executed by said printer, said XML interpreter being adapted to receive, store, navigate through and retrieve XML elements from an incoming data stream and to call a formatting program inside said printer and allow said formatting program to perform rule-based formatting of the information carried by the XML structure, said XML interpreter comprising:
an XML parser for building a DOM tree; and
an XPath processor comprising an XPath parser for parsing an XPath string into a data structure and an XPath interpreter which receives the data structure from the XPath parser and retrieves the data from said DOM tree.

In accordance with another aspect of the present invention, there is provided a printer comprising an XML interpreter loaded in said printer, said XML interpreter being adapted to be executed by said printer, said XML interpreter being adapted to receive, store, navigate through and retrieve XML elements from an incoming data stream and to call a formatting program inside said printer and allow said formatting program to perform rule-based formatting of the information carried by the XML structure, said XML interpreter comprising:
an XML parser for building a DOM tree; and

an XPath processor comprising an XPath parser for parsing an XPath string into a data structure and an XPath interpreter which receives the data structure from the XPath parser and retrieves the data from said DOM tree.

In accordance with yet another aspect of the present invention, there is provided a method for transforming a printer into an XML printer comprising the step of loading into said printer an XML interpreter into RAM or permanent storage.

In accordance with another aspect of the present invention, there is provided a method of sending XML data to an XML printer comprising the step of prefixing the XML data with a trigger that starts an XML interpreter, which in turn will read and store said XML data into at least one XML DOM tree.

In accordance with another aspect of the present invention, there is provided a method of sending XML data to an XML printer without the need of a trigger comprising the step of modifying the startup files of said XML printer to automatically start an XML interpreter.

In accordance with another aspect of the present invention, there is provided a method of selecting a formatting program to execute, based on XML data, comprising a formatting program selection program that utilizes an XPath processor of an XML interpreter that reads said XML data to examine said XML data and to select and start a formatting program based on said XML data.

### BRIEF DESCRIPTION OF THE DRAWINGS

The present invention will be better understood after reading a description of a preferred embodiment thereof, made in reference to the following drawings, in which:

FIG. 1 is a schematic representation of how to print XML data according to the prior art;

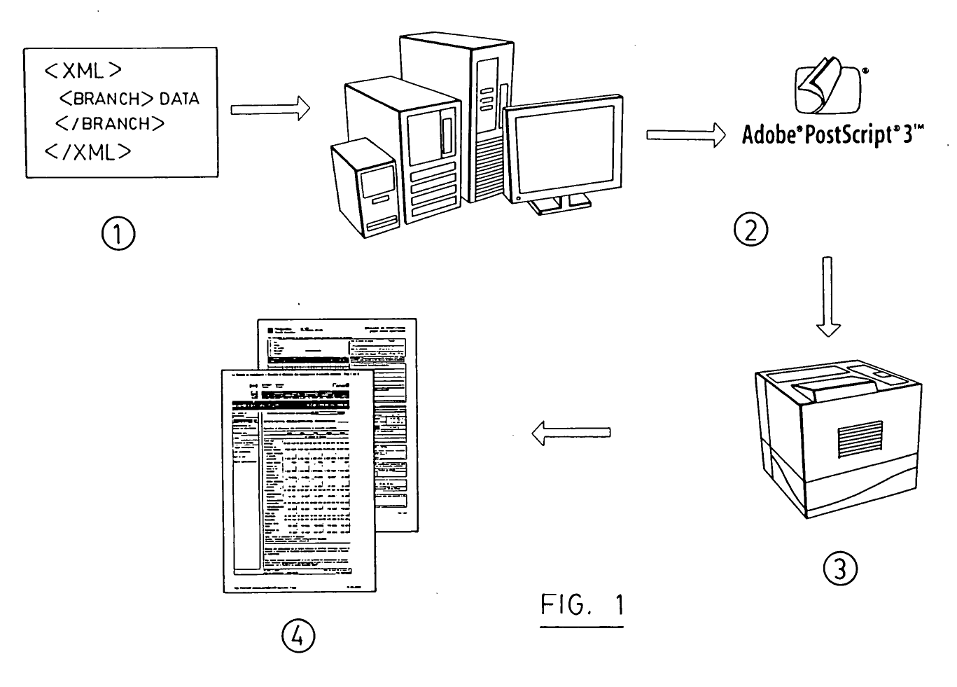

FIG. 2 is a schematic representation of how to print XML data according to a preferred embodiment of the invention; and

FIG. 3 is a schematic representation of an XML data stream.

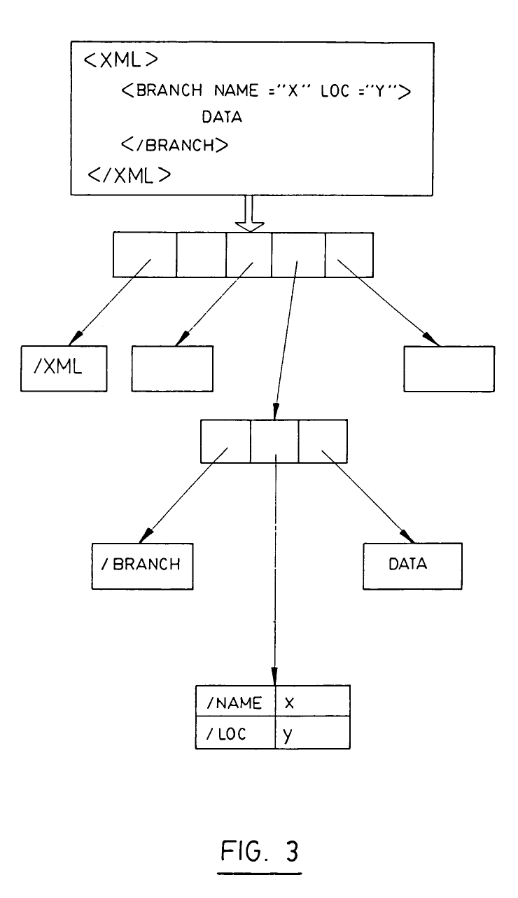

### DESCRIPTION OF A PREFERRED EMBODIMENT OF THE INVENTION

The invention we propose here is to allow sending the XML data directly to the printer thereby allowing a formatting program to navigate through the XML data, retrieve values from it and map them into the document's ultimate printed format.

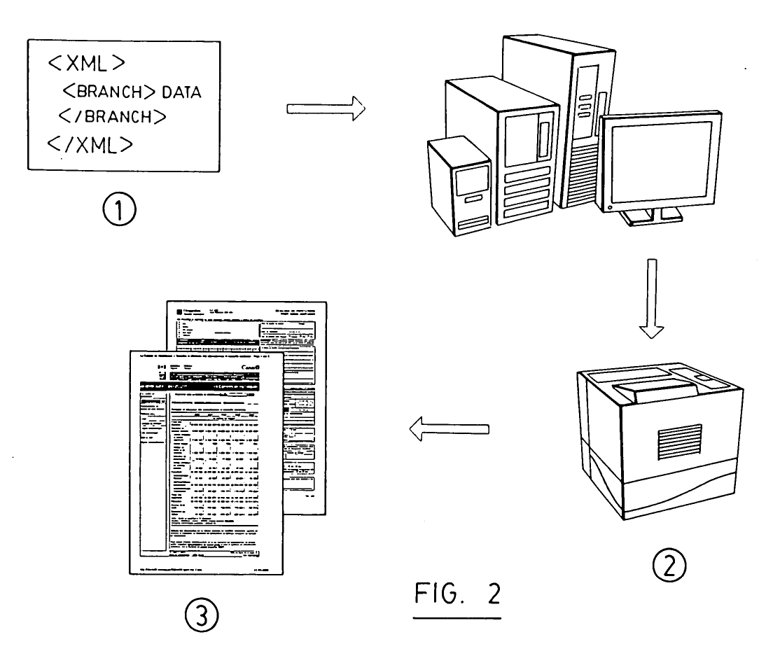

The approach of the present invention can be schematized as follows, when referring now to FIG. 2:
1 ) The host computer processes a XML structure that is either generated or stored and sends it, as is, to the printer.
2) The printer, upon reception of the XML data, stores it in memory.
3) A formatting program inside the printer is invoked to select and format the information into a printed document.

The present invention turns any existing printer that supports the PostScript language into an XML-enabled printer and enables PostScript based formatting programs to access and print the data contained in an XML data stream. However, it will be appreciated by those skilled in the art that the present invention is equally applicable to printers that support being sent programs that may process data streams sent to the printer.

A first component of the present invention is an XML interpreter which can be executed by the PostScript interpreter inside of a printer to receive, store, navigate through and retrieve specific XML elements from an incoming data stream. This XML interpreter provides the necessary functionality to call a PostScript formatting program and allow it to perform rule-based formatting of the information carried by the XML structure.

The navigation provides a simple way of accessing and processing elements from XML data streams by using a path-based syntax to navigate the XML's logical structure or hierarchy. This provides users with a higher level of abstraction when working with XML data, because they are not required to understand or parse through the syntax definition of the markup language.

The XML interpreter consists of an XML parser and an XPath processor and is combined with a rule based formatting program selector written in the PostScript language. The formatting program selector inspects the XML data stream and calls the appropriate PostScript formatting program. The PostScript XML parser provides routines to read a single-byte (such as iso-latin-1) or multi-byte (such as UTF-8 or UTF-16) encoded XML data stream and store the XML data in a data structure resembling a XML DOM (Document Object Model) tree. The XPath processor provides routines to access that data structure using (a subset of) XPath syntax.

The routines in the traditional PostScript formatting programs that read and buffer the data stream are replaced with routines that call the XML parser, which will read the XML data structure and store the XML data as a tree structure implemented using PostScript arrays and dictionaries. The access routines of the PostScript formatting program are replaced with routines that call the XPath processor to select parts of an XML data stream using XPath syntax. Alternatively the formatting program may directly access the stored XML data using standard PostScript array and dictionary functions.

Existing PostScript formatting programs may be used unmodified by using a special PostScript program that uses the XML interpreter to translate the data retrieved from the XML data-stream back into a record based data stream and redirecting the input of the PostScript formatting program to that generated data stream. In this case the XML interpreter calls the special PostScript program which reformats the XML data and calls the unmodified PostScript formatting program.

The XML interpreter may be combined with the XML data and sent as a whole to the PostScript printer. Alternatively the XML interpreter may have been stored in RAM or on some form of permanent storage (such as a hard-disk) in the PostScript printer. In such cases the XML data stream can be combined with a trigger that starts the XML interpreter, which then processes the XML data. The trigger consists of a PostScript call to a named PostScript routine installed in RAM by the downloaded XML interpreter or consists of the execution of a file present on the PostScript printer that loads and executes the XML interpreter. If the printer supports disabling PDL auto-detection, the trigger may be omitted by installing the trigger for the XML Interpreter into the PostScript Interpreter startup files. Using the latter method the original XML data can be directly sent to the printer.

The XML interpreter calls the PostScript formatting program selection code which in turn executes the appropriate PostScript formatting program. The PostScript formatting program selection code is in fact just another PostScript formatting program that uses the XPath processor to examine the XML data and determine which other PostScript formatting program to execute. The advantage of this approach is that the formatting program selection code can be replaced without needing to re-install the XML interpreter software onto the printer. Note that this approach also allows different parts of the XML data stream to be processed by different formatting programs.

In a present form, a user can write a script (in PressTalk or JavaScript) which is translated (compiled) into PostScript code. Library functions are provided to access the XML data using XPath syntax, manipulate data using string functions, draw text, vector graphics, barcodes, graphs, charts and display images and call other formatting programs. The compiler contains PostScript code that implement the library functions on the printer. A graphical design tool is provided to aid users in the creation of such scripts. Download tools are provided to install the generated PostScript formatting program or formatting program selection code into RAM or onto permanent storage (hard disk, flash, etc.) in a PostScript printer.

The XML Parser

The XML parser utilizes several lookup tables to store character codes with similar purposes. Each lookup table represents either a set of characters that determine the valid characters in a token, or the set of characters that signify the (possible) end of a token. Tokens are sequences of characters that form an identifier or name, white space, attribute value, entity reference, start/end element, etc.

Each tokenization routine receives the next character in the stream and performs a loop using a lookup table to determine whether the character is part of the token or (possibly) ends a token. The characters that compose the token are stored in a temporary buffer (except for certain types of white space) and are converted into a string or name so that the token can be stored in the DOM data structure. The last character read that is not part of the token is returned from the tokenization routine so that it may be passed to the next tokenization routine. Which tokenization routine is to be called is generally decided using a lookup table that maps character codes to (possibly anonymous) procedures, implementing a switch (which is not directly available in PostScript).

The tokenization routines work together, storing temporary results on the stack. At the beginning of a syntactic construct, the stack is marked in such a way that at the end of the construct the elements on the stack can be gathered together into a partial DOM tree. Using recursion, child elements are parsed and leave a DOM sub-tree on the stack. In effect, this builds up the DOM tree from bottom to top and from left to right.

Each node in the DOM tree is stored in a PostScript array, making use of the fact that PostScript arrays can store objects of mixed types. Note that the actual representation in PostScript memory may be varied to optimize for minimal storage, maximum parsing speed or maximum retrieval speed.

In the current implementation of the present invention, the first two elements in the array are used for meta-information, such as the name of the element, the attributes and the type of special nodes. The other elements in the array store the contents of the node. Text nodes are optimized and are stored directly as one or more strings.

For XML nodes the first element of the array contains the name (as a PostScript name object), the second element contains the attributes (as a PostScript dictionary mapping attribute names to values) and the remaining elements each contain either a DOM tree or a text node (stored as a PostScript string).

For special nodes like comments, processing instructions, etc., the first element of the array contains a null object and the second element contains the name of the special node (stored as a PostScript name). In the case of processing instructions, comments and inline DTD definition nodes, the third element of the array contains the text of the node. For a DOCTYPE node the third element contains the system ID and the fourth element contains the public ID of the DTD. Either may be null, if it was not specified in the XML data stream. The other elements of the DOCTYPE array each contain a DOM node for the inline definitions in the DOCTYPE definition.

A special marker node is created for the top of the tree to store the root node plus all the nodes derived from the optional DOCTYPE definition, comments and processing instructions that may precede the definition of the root node in a XML data stream.

The XML parser has the option of reading the XML data stream in chunks. In that case, the XML parser returns after parsing a node matching some criterion, returning a DOM tree for that child node. This allows an XML data stream to be processed without the need to store the complete DOM tree in memory. Examples of node selection criteria may be to select nodes that are a child of the root node, or nodes that have a specific name or nodes that contain a node with a specific value.

The XPath Processor

The XPath processor supports a subset of the XPath syntax to access data stored in a DOM tree. At the very least, the XPath processor supports element selection by name and/or position, attributes selection and can return the name of an element or attribute.

The XPath processor is split into two parts: the XPath parser and the XPath interpreter. The XPath parser parses an XPath string into a data structure that can be passed to the XPath interpreter to retrieve the data from a given DOM tree.

The XPath parser stores the parsed XPath expression in an array of pairs. The first element contains the name; the second element contains the position. If no position is specified, a negative number is stored for the position. Note that the XPath parser does not validate the name and does not distinguish between element and attribute names or wildcards; this is done in the XPath interpreter.

The XPath interpreter takes the parsed XPath expression and traverses the DOM tree, matching each node against the XPath expression. As the DOM tree is traversed the XPath interpreter leaves, on the stack, those text nodes that match the XPath expression. Only the parts of the DOM tree that partially match the XPath expression are traversed, speeding up the search process. Once the search is complete, the found text nodes are concatenated and returned as a single string. Using the example, the XPath expression “/XML/Branch” would return the string “Data ”. The resulting string can then be formatted and displayed by a PostScript formatting program just as if the presentation program had selected data from a location in a fixed buffer.

The advantages of the present invention are readily apparent. Since the XML data structure is much less cumbersome, significant bandwidth savings are available, since only the XML data is sent to the printer. It is the printer itself which interprets the XML data and produces the final print.

Although the present invention has been explained hereinabove by way of a preferred embodiment thereof, it should be pointed out that any modifications to this preferred embodiment within the scope of the appended claims is not deemed to alter or change the nature and scope of the present invention.

1. An XML interpreter, said XML interpreter being adapted to be loaded into a printer and executed by said printer, said XML interpreter being adapted to receive, store, navigate through and retrieve XML elements from an incoming data stream and to call a formatting program inside said printer and allow said formatting program to perform rule-based formatting of the information carried by the XML structure, said XML interpreter comprising:
an XML parser for building a DOM tree; and
an XPath processor comprising an XPath parser for parsing an XPath string into a data structure and an XPath interpreter which receives the data structure from the XPath parser and retrieves the data from said DOM tree.

2. An XML interpreter according to claim 1, wherein said formatting program of said printer is written in PostScript.

3. An XML interpreter according to claim 2, wherein said XML parser utilizes a plurality of lookup tables to store character codes for the purpose of tokenization and uses a plurality of tokenization routines that interact to create a DOM tree from (parts of) an XML data stream.

4. A printer comprising an XML interpreter loaded in said printer, said XML interpreter being adapted to be executed by said printer, said XML interpreter being adapted to receive, store, navigate through and retrieve XML elements from an incoming data stream and to call a formatting program inside said printer and allow said formatting program to perform rule-based formatting of the information carried by the XML structure, said XML interpreter comprising:
an XML parser for building a DOM tree; and
an XPath processor comprising an XPath parser for parsing an XPath string into a data structure and an XPath interpreter which receives the data structure from the XPath parser and retrieves the data from said DOM tree.

5. A printer according to claim 4, wherein said printer further includes RAM, and wherein said XML interpreter is loaded into said RAM.

6. A printer according to claim 4, wherein said printer includes a permanent storage such as a hard drive or flash storage.

7. A printer according to claim 4, wherein said formatting program of said printer is written in PostScript.

8. A method for transforming a printer into an XML printer comprising the step of loading into said printer an XML interpreter according to claim 1 into RAM or permanent storage.

9. A method of sending XML data to an XML printer comprising the step of prefixing the XML data with a trigger that starts an XML interpreter according to claim 1, which in turn will read and store said XML data into at least one XML DOM tree.

10. A method of sending XML data to an XML printer without the need of a trigger comprising the step of modifying the startup files of said XML printer to automatically start an XML interpreter according to claim 1.

11. A method of selecting a formatting program to execute, based on XML data, comprising a formatting program selection program that utilizes an XPath processor of an XML interpreter according to claim 1 that reads said XML data to examine said XML data and to select and start a formatting program based on said XML data.
